(19) United States
(12) Patent Application Publication
(10) Pub. No.: US 2018/0080275 A1
(43) Pub. Date: Mar. 22, 2018

(54) DOOR, ADAPTABLE TO DIFFERENT OPENINGS

(71) Applicant: NORMA DOORS TECHNOLOGIES, S.A., San Leonardo Yague (ES)

(72) Inventors: Miguel Angel BOROBIO MUNERA, San Leonardo Yague (ES); Carlos CONDADO CABREJAS, San Leonardo Yague (ES)

(21) Appl. No.: 15/568,189

(22) PCT Filed: Apr. 13, 2016
(86) PCT No.: PCT/ES2016/070255

§ 371 Date: Oct. 20, 2017

(30) Foreign Application Priority Data
Apr. 20, 2015 (ES) P201530526

(51) Int. Cl. E06B 3/70

(52) U.S. Cl. CPC E06B 3/70; E06B 2003/7096; E06B 2003/7051

(57) ABSTRACT

A door that can be adapted to different spans is provided, structured in a first element (1) and at least a second element (2) attached in a coplanar manner to the former, including both (sets of openings (31) in one and a number of shafts/rod (32) in the other) for permitting a linear nearing/distancing movement between both elements (1, 2), and means (screws) for holding the elements to one another in any position. On at least one of their edges, the outer surfaces of one of the elements (1, 2) extend into respective superficial tabs (51, 52) between which a longitudinal recess (50) is defined, in which the facing edge (60) of the other element (1, 2) is accommodated, such that said edge (60) is guided and obscured from vision, providing continuity to the surface of the door.

### OBJECT OF THE INVENTION

The object of the invention refers, in general, to a door adaptable to different openings and, most particularly, to a door leaf that can vary its surface (in width and/or in height) to exercise its function in different openings.

### BACKGROUND OF THE INVENTION

In the current state-of-the art, doors and windows to exercise their functions in different openings are common knowledge. To close the openings, door or window leaves are used, each adjusted to its related frame, is dimensionally adapted to the opening where it is placed and allows to close it. Alternatively, several door or window leaves (generally two hinged to the two opposite stiles of the frame) can close a single opening.

In the current state-of-the-art, all the doors or windows leaves, when already produced and finished, show a fixed surface. The applicant is not aware, in the current state-of-the-art, of any door or window leaf that, after being produced, can vary its surface (either in width, in height or in both of them) to “adapt itself” to different openings.

### DESCRIPTION OF THE INVENTION

The door adaptable to different openings, according to the invention, is characterized in that it is structured in a first element and, at least a second element attached coplanar to the former; having available as many means to allow the linear forward/backward transfer between both elements as means to hold them down to each other in any position. With this structuring, a same door, after it has been produced, can vary its total surface to adapt itself to different openings.

It is also characterized in that the said means to allow the linear forward/backward transfer between two contiguous elements are sets of holes in one of them and pins/rod in the other. The pins/rod of one of the elements are moved guided housed in the holes of the other to achieve the different width of the door.

It is also characterized in that the said means to hold down each two contiguous elements to each other are screws that, inserted from the related rim of the said first element, reach the related pin/rod housed in the related hole of the said second element.

It is also characterized in that in at least one of its rims, the external surfaces of one of the elements is extending in both superficial flanges between which a lengthwise recess is defined in which is housed the opposite rim of the other element. The said rim remains guided and hidden to the view, providing continuity to the surface of the door.

It is also characterized in that, namely, two second elements are arranged attached on two opposite edges of the first element. It is indistinct to the effects of the invention and it is included in its object, that the opposite edges are lateral (in which case the door results of a variable width); the lower and the upper (in which case the door results of a variable height); or both (in which case the door results of a variable width and a variable height).

Advantages of the door object of the invention are, inter alias, making possible it is produced in large series without it is necessary to know in advance the place where they are to be installed.

Other configurations and advantages of the invention can be deducted from the following description and the dependant claims.

### DESCRIPTION OF THE DRAWINGS

To best understand the object of the invention, a preferred embodiment is shown in the figures attached hereto, that can be subject to accessory changes that do not impair its fundament. In this case:

FIG. 1 shows a general schematic elevation view of a door according to the invention; with a first element (1) and two second elements (2) in mounting arrangement.

FIG. 2 shows a general schematic plan view, corresponding to the preceding figure, in which the hold down screws (4) arrangement can be seen.

FIG. 3 shows a general schematic section, according to the indication A: A of the FIG. 1.

FIGS. 4a and 4b show both general schematic plan sections in which two different widths for the door of this invention can be seen.

### DESCRIPTION OF A PREFERRED EMBODIMENT

A non-limiting example of a practical embodiment of this invention is disclosed below. Other embodiments are absolutely not discarded in which accessory changes can be introduced that do not impair its fundament.

The adaptable door with different openings according to the invention is structured, at least, in:
a first element (1);
a second element (2) attached coplanar to the preceding one;
means to allow the linear forward/backward transfer between both elements (1), (2); and
means to hold down both elements (1), (2) to each other in any position.

Starting from this basic structuring, are included in the object of the invention any embodiments that do not alter, change or modify the proposed essence.

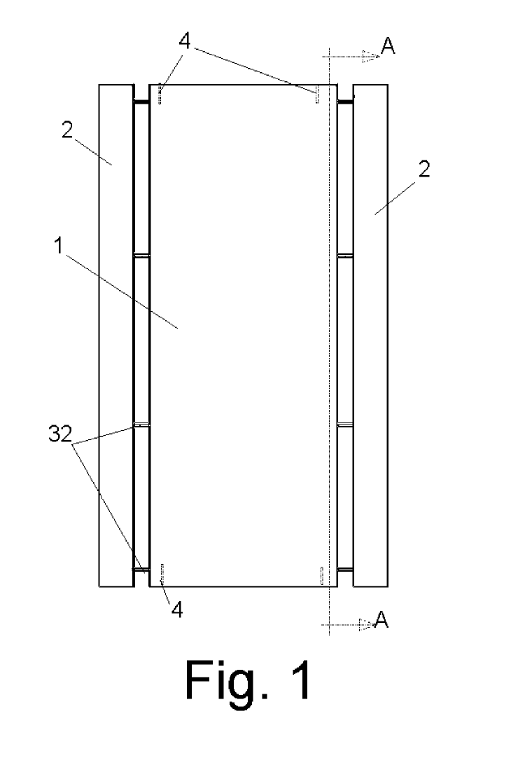

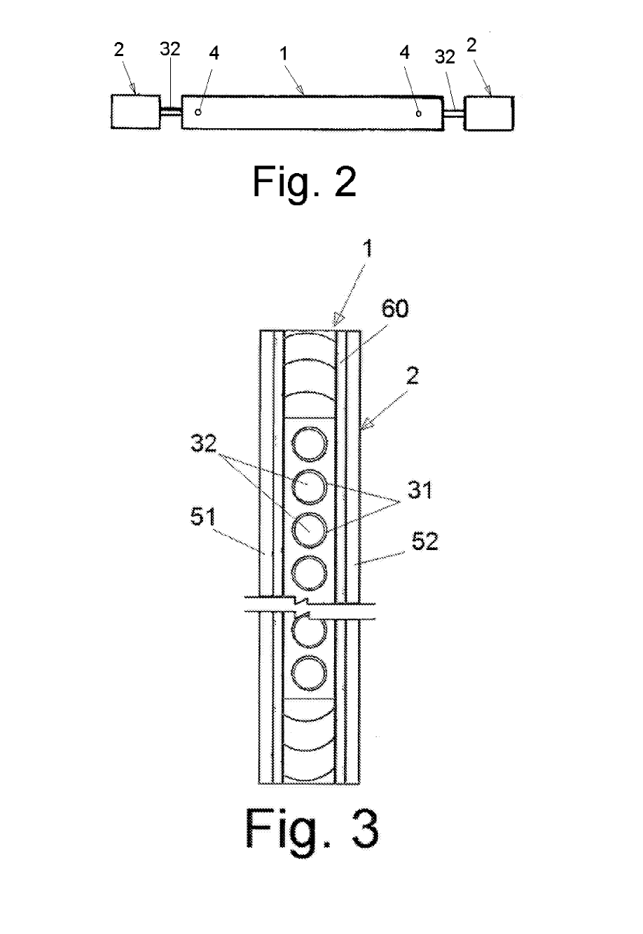

Namely, is included in the object of the invention arranging two second elements (2) attached on both sides or opposite edges of a first element (1). See FIG. 1.

For the example of embodiment represented, the said means to allow the linear forward/backward transfer between two contiguous elements (1), (2), there is a set of holes (31) pierced in one of the elements (1), (2); and pins/rod (32) carried out in the other element (1), (2).

For the purpose of the invention it is indistinct which is the element (1), (2) having the holes (31) and which is having the pins-rod; as well as the number of sets of holes (31) and pins/rod (32) used.

For the purpose of the invention it is basic that each pins/rod (32) is housed in a facing hole (31) and that it is transferred guided within it to achieve the different width of the door.

For the example of embodiment shown, the said means to hold down each two elements (1), (2) to each other are screws (4) that, inserted from the related rim (10) of the said first element (1), reach and hold down the related pin/rod (32) housed in the related hole (31) of the said second element (2).

To the effect of the invention, it is indistinct which are the rims (10) of the element (1) from which the screws (4) are inserted: it can be the upper, the lower or both as in the embodiment shown, but also they can be lateral if one or both second elements (2) were arranged at the top/bottom.

that it has the holes (31) and which has the pins-rod; as well as the number of sets of holes (31) and pins/rod (32) used.

It is basic to the effects of the invention that the screws (4) reach and hold down the pins/rod (32) because, as they are fixed to one of the elements (1), (2), both elements are holding down each other.

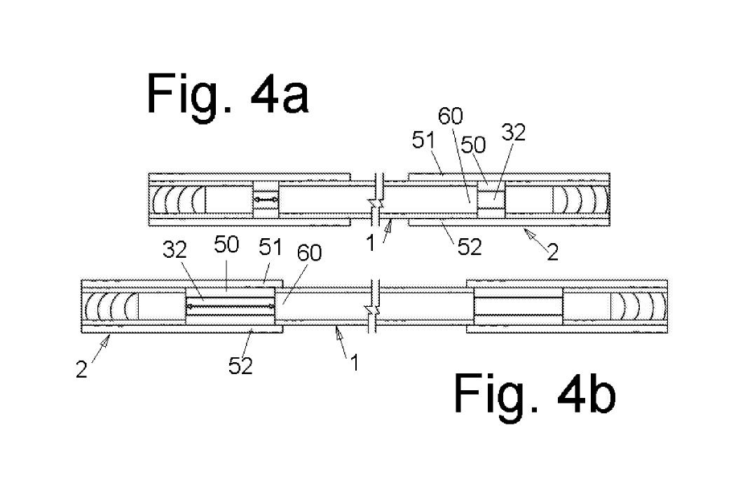

According to the invention, the external surfaces of one of the elements (1) (2) extend, at least in one of its rims, to both superficial flanges (51), (52) between which a lengthwise recess (50) is defined. According to the embodiment shown, the second element (2) is the element that has the superficial flanges (51), (52) between which a lengthwise recess (50) is defined. See FIGS. 4a and 4b.

In the recess (50) defined between these superficial flanges (51), (52) and the own body of the said second element (2) the facing rim (60) of the first element (1) is housed so that the said rim (60) remains guided and hidden to the view, providing continuity to the surface of the door.

To the effect of the invention, it is indistinct and it is included in its object that the superficial flanges (51), (52) and ensuing lengthwise recess (50) are defined in the first element (1) or in the second element (2): anyway, the rim of the other element is housed and remains guided in the recess (50) hidden from the view and providing continuity to the surface of the door.

Can be variable the materials, sizes, proportions and, in general, those other details either accessory or secondary that do not alter, change or modify the proposed essence.

The terms of the wording of this specification are the true and faithful reflection of the object disclosed, having to be taken in their broadest sense and never in a limiting manner.

1. A door adaptable to different openings, characterized in that it is structured in a first element (1) and at least, a second element (2) attached coplanar to the preceding, arranging as many means to allow the linear forward/backward transfer between both elements (1), (2) as means to hold them down to each other in any position; so that, after it is produced, a same door can vary its total surface, to adapt itself to different openings.

2. The door, according to the claim 1, characterized in that two second elements (2) are arranged attached to two opposite edges of the said first element (1).

3. The door according to claim 1, characterized in that the said means, in order to allow the linear forward/backward transfer between two contiguous elements (1), (2) are sets of holes (31) in one of them and pins/rod (32) in the other; so that the pins/rod (32), are transferred guided housed in the holes (31) to achieve the different width of the door.

4. The door, according to claim 1, characterized in that the said means to hold down two elements (1), (2) to each other are screws (4) that, inserted from the related rim (10) of the said first element (1), reaches the related pin/rod (32) housed in the related hole (31) of the said second element (2).

5. The door, according to claim 1, characterized in that, in at least one of its rims, the external surfaces of one of the elements (1), (2) extend in both superficial flanges (51), (52) between which a lengthwise recess (50) is defined in which the facing rim (60) of the other element (1), (2) is housed; so that the said rim (60) remains guided and hidden from view providing continuity to the door surface.

6. The door according to claim 2, characterized in that the said means, in order to allow the linear forward/backward transfer between two contiguous elements (1), (2) are sets of holes (31) in one of them and pins/rod (32) in the other; so that the pins/rod (32), are transferred guided housed in the holes (31) to achieve the different width of the door.

7. The door, according to claim 2, characterized in that the said means to hold down two elements (1), (2) to each other are screws (4) that, inserted from the related rim (10) of the said first element (1), reaches the related pin/rod (32) housed in the related hole (31) of the said second element (2).

8. The door, according to claim 3, characterized in that the said means to hold down two elements (1), (2) to each other are screws (4) that, inserted from the related rim (10) of the said first element (1), reaches the related pin/rod (32) housed in the related hole (31) of the said second element (2).

9. The door, according to claim 2, characterized in that, in at least one of its rims, the external surfaces of one of the elements (1), (2) extend in both superficial flanges (51), (52) between which a lengthwise recess (50) is defined in which the facing rim (60) of the other element (1), (2) is housed; so that the said rim (60) remains guided and hidden from view providing continuity to the door surface.

10. The door, according to claim 3, characterized in that, in at least one of its rims, the external surfaces of one of the elements (1), (2) extend in both superficial flanges (51), (52) between which a lengthwise recess (50) is defined in which the facing rim (60) of the other element (1), (2) is housed; so that the said rim (60) remains guided and hidden from view providing continuity to the door surface.

11. The door, according to claim 4, characterized in that, in at least one of its rims, the external surfaces of one of the elements (1), (2) extend in both superficial flanges (51), (52) between which a lengthwise recess (50) is defined in which the facing rim (60) of the other element (1), (2) is housed; so that the said rim (60) remains guided and hidden from view providing continuity to the door surface.
